(19) United States
(12) Patent Application Publication
(10) Pub. No.: US 2020/0247378 A1
(43) Pub. Date: Aug. 6, 2020

(54) VACUUM BOOSTER DEVICE

(71) Applicant: ADVICS CO., LTD., Kariya-shi, Aichi-ken (JP)

(72) Inventor: Kimiyasu SUZUKI, Gamagori-shi, Aichi-ken (JP)

(73) Assignee: ADVICS CO., LTD., Kariya-shi, Aichi-ken (JP)

(21) Appl. No.: 16/756,039

(22) PCT Filed: Oct. 25, 2018
(86) PCT No.: PCT/JP2018/039576

§ 371 Date: Apr. 14, 2020

(30) Foreign Application Priority Data
Oct. 25, 2017 (JP) 2017-206493

(51) Int. Cl. B60T 13/57; B60T 15/00; F16K 15/02

(52) U.S. Cl. CPC B60T 13/57; F16K 15/028; B60T 15/00

(57) ABSTRACT

A check valve of a vacuum booster device is provided with a main body assembled in a vacuum pressure inlet port, a first passage, an accommodating portion and a second passage, a valve seat formed in the first passage, a valve body accommodated in the accommodating portion, and a spring which urges the valve body toward the valve seat. The spring is configured to include an end coil portion which engages with a spring seat, an expanding and contracting coil portion which expands and contracts and is separated from a flange portion of the valve body, and a linking coil portion which is separated from the flange portion and the spring seat and links the end coil portion and the expanding and contracting coil portion.

### TECHNICAL FIELD

The present invention relates to a vacuum booster device.

### BACKGROUND ART

A check valve vacuum pressure booster disclosed in Patent Literature 1 below, for example, is conventionally known. A check valve assembled to the conventional vacuum pressure booster includes a vacuum pressure outlet hole (vacuum pressure outlet port) and a valve seat formed at the vacuum pressure outlet hole (vacuum pressure outlet port) in a housing main body, so that a valve body that cooperatively operates with the valve seat and a valve spring for seating the valve body on the valve seat are accommodated. In the check valve disclosed in Patent Literature 1, in order to suppress the vibration of the valve spring and the valve body caused by the intermittent intake action of a vacuum pressure source, the coil winding pitch of the valve spring is made different to suppress the resonance of the valve spring and the valve body.

### CITATIONS LIST

### Patent Literature

Patent Literature 1: Japanese Unexamined Patent Application Publication No. 6-55915

### SUMMARY OF INVENTION

### Technical Problems

In the check valve provided between the vacuum pressure source and the vacuum booster device, the valve spring may expand and contract by the intermittent intake action (vacuum pressure pulsation) of the vacuum pressure source in a state in which the valve body is not completely separated from the valve seat or a seated state, and an end of the valve spring (end on an end coil portion side) may abut against a groove portion (lock portion) for locking the valve body and an outer peripheral portion (flange portion) of the valve body at the time of expansion and contraction thus vibrating the valve body, so that the valve body may repeat seating and separation with respect to the valve seat. Thus, in a state in which the entire valve body vibrates and the entire valve body repeats seating and separation with respect to the valve seat, abnormal noise (abutment noise) may generate by the abutment between the valve body and the valve seat.

The present invention has been contrived to solve the above problems. That is, an object of the present invention is to provide a vacuum pressure type booster device capable of suppressing the occurrence of vibration and abnormal noise (abutment noise) of a check valve caused by the vacuum pressure pulsation.

### Solutions to Problems

In order to solve the problems described above, a vacuum booster device including a hollow booster shell; a movable partition wall that air-tightly partitions the booster shell into a vacuum pressure chamber and a variable pressure chamber; a booster piston that is provided to be relatively movable with respect to the booster shell, and that moves integrally with the movable partition wall inside the booster shell; and a check valve that is assembled to a vacuum pressure inlet port communicating with the vacuum pressure chamber of the booster shell and connected to a vacuum pressure source of a vehicle, and that allows communication of air from the vacuum pressure inlet port toward the vacuum pressure source and shuts off communication of the air from the vacuum pressure source toward the vacuum pressure inlet port; where the check valve includes, a main body provided to connect with the vacuum pressure inlet port, a passage that is formed in the main body to communicate the vacuum pressure inlet port and the vacuum pressure source, a valve seat formed in the passage, a valve body that is accommodated in the passage and seated on or separated from the valve seat, and that includes a cylindrical base that extends into the passage in a direction of an axis, a disk that extends along a radial direction of the base, an annular protrusion that projects out toward the valve seat from an outer peripheral end of the disk, and a groove-shaped lock portion provided on the base to extend along the radial direction of the base and include a flange portion facing the disk and the disk, and a spiral-shaped urging member that is accommodated in the passage and that urges the valve body toward the valve seat to bring the protrusion into contact with the valve seat; and the urging member is configured to include, an end coil portion locked to the lock portion, an expanding and contracting coil portion that makes contact with the main body and is separated from the flange portion, and that expands and contracts according to the seating or separation of the valve body, and a linking coil portion that links a winding end portion of the end coil portion that becomes a base point separated from the lock portion and a winding end portion of the expanding and contracting coil portion separated from the flange portion on the valve body side, and that separates the winding end portions from the flange portion and the lock portion.

### Advantageous Effects of Invention

Thus, the linking coil portion linking the end coil portion and the expanding and contracting coil portion of the urging member can be separated from the flange portion of the valve body. Thus, when a vacuum pressure pulsation occurs in the passage during the seated state in which the valve body is seated on the valve seat, and the expanding and contracting coil portion of the urging member expands/contracts and vibrates, the expanding and contracting coil portion and the linking coil portion can be avoided (suppressed) from abutting against the flange portion and the lock portion of the valve body. Therefore, even if the expanding and contracting coil portion of the urging member is expanded and contracted by the vacuum pressure pulsation, the urging member does not vibrate the valve body, so that an abnormal sound (abutment noise) generated when the valve body repeatedly abuts against the valve seat can be suppressed.

### BRIEF DESCRIPTION OF DRAWINGS

FIG. 1 is a schematic overall view of a vacuum booster device according to the present invention.

FIG. 2 is a cross-sectional view schematically showing a configuration of a check valve assembled to the vacuum booster device of FIG. 1

FIG. 3 is a view describing a winding diameter of a spring forming a check valve of FIG. 2.

FIG. 4 is a view describing a winding pitch of the spring forming the check valve of FIG. 2.

FIG. 5 is a view describing a position relationship between an end coil portion, an expanding and contracting coil portion, and a linking coil portion of a spring and a flange portion and a spring seat of a valve body.

FIG. 6 is a cross-sectional view schematically showing a configuration of a check valve assembled to the vacuum booster device of FIG. 1 according to a modified example of the embodiment.

FIG. 7 is a cross-sectional view schematically showing a configuration of a check valve assembled to the vacuum booster device of FIG. 1 according to another modified example of the embodiment.

FIG. 8 is a cross-sectional view schematically showing a configuration of a check valve assembled to the vacuum booster device of FIG. 1 according to another modified example of the embodiment.

### DESCRIPTION OF EMBODIMENT

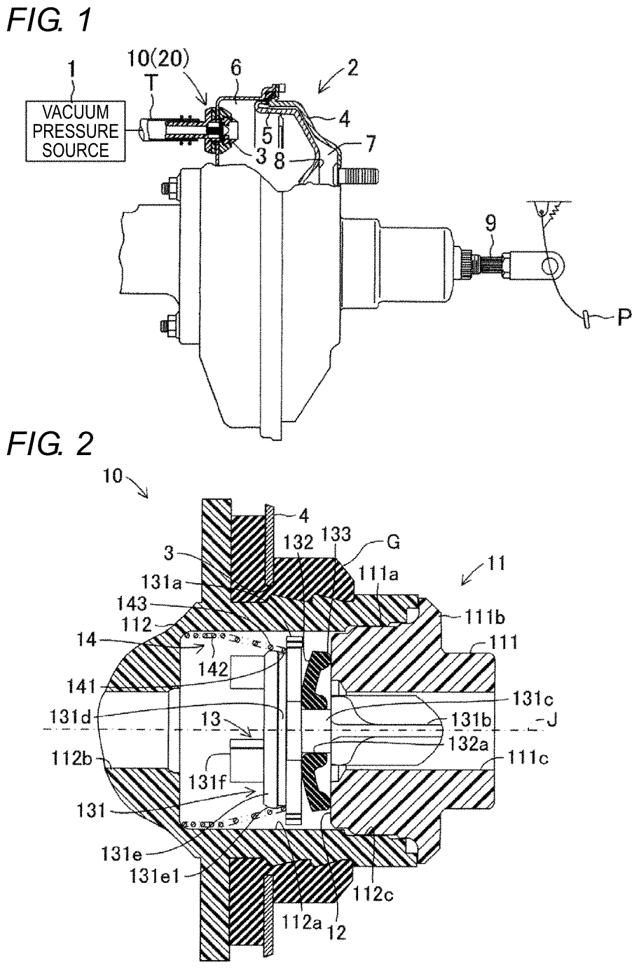

Hereinafter, an embodiment of the present invention will be described with reference to the drawings. As shown in FIG. 1, a vacuum booster device 2 connected to a vacuum pressure source 1 of a vehicle includes a hollow booster shell 4 formed with a vacuum pressure inlet port 3, and a check valve 10 having one side connected to a connecting pipe T connected to the vacuum pressure source 1 and the other side connected to the vacuum pressure inlet port 3 of the vacuum booster device 2 and being arranged on a flow path connecting the vacuum pressure source 1 and the vacuum pressure inlet port 3.

The vacuum pressure source 1 is, for example, an engine manifold or the like, and generates a vacuum pressure. The inside of the booster shell 4 is divided into a vacuum pressure chamber 6 and a variable pressure chamber 7 by a movable partition wall 5. In the vacuum pressure chamber 6, a vacuum pressure inlet port 3 is provided. As shown in FIGS. 1 and 2, the vacuum pressure inlet port 3 is formed on the wall surface of the booster shell 4 forming the vacuum pressure chamber 6 to communicate the inside and the outside of the vacuum pressure chamber 6. Returning to FIG. 1, a booster piston 8 is connected to the movable partition wall 5. The booster piston 8 is provided so as to be relatively movable with respect to the booster shell 4, and is connected to one end side of an input rod by way of a control valve (not shown). A brake pedal P is connected to the other end side of the input rod 9.

In the vacuum booster device 2, when the brake pedal P is not depressed, the input rod 9 retreats together with the brake pedal P. Then, the control valve (not shown) controls the variable pressure chamber 7 and the vacuum pressure chamber 6 so as to have the same pressure, so that the booster piston 8 also returns to the retreated position. On the other hand, when the brake pedal P is depressed, the input rod 9 advances together with the brake pedal P. The atmospheric pressure is introduced into the variable pressure chamber 7 by the switching operation of the control valve (not shown), and the booster piston 8 is urged in an advancing direction by the pressure difference (vacuum pressure difference) between the variable pressure chamber 7 and the vacuum pressure chamber 6.

When the atmospheric pressure is introduced into the variable pressure chamber 7 and the booster piston 8 advances, a part of the air introduced into the variable pressure chamber 7 flows into the vacuum pressure chamber 6. The inflowing air flows toward the vacuum pressure source 1 through the check valve 10 and the connecting pipe T. The check valve 10 is a valve mechanism that allows communication of air from the vacuum booster device 2 side toward the vacuum pressure source 1 side, and shuts off the communication of air from the vacuum pressure source 1 side toward the vacuum booster device 2 side. Thus, the check valve 10 allows the communication of air from the vacuum pressure chamber 6 to the connecting pipe T by opening, so that the air in the vacuum pressure chamber 6 flows toward the vacuum pressure source 1. The air in the vacuum pressure chamber 6 is thereby taken in by the vacuum pressure source 1, and the pressure in the vacuum pressure chamber 6 is made equal to the pressure (vacuum pressure) of the vacuum pressure source 1. Furthermore, for example, when the pressure of the vacuum pressure source 1 becomes higher than the pressure of the vacuum pressure chamber 6 accompanying the stopping of the engine, the check valve 10 shuts off the communication of air from the connecting pipe T to the vacuum pressure chamber 6 by closing, so that the pressure (vacuum pressure) of the vacuum pressure chamber 6 is maintained.

As shown in FIG. 2, the check valve 10 is air-tightly assembled to a vacuum pressure inlet port 3 formed in the booster shell 4 through a grommet G. The check valve 10 includes a main body 11, a valve seat 12, a valve body 13, and a spring 14 as an urging member.

The main body 11 includes a first main body portion 111 and a second main body portion 112. The first main body portion 111 is formed in a tubular shape, and has a projecting portion 111a, a flange portion 111b, and a first passage 111c. The projecting portion 111a is connected to the second main body portion 112. The flange portion 111b abuts against the second main body portion 112. The first passage 111c that forms the passage communicates the inside and the outside of the vacuum pressure chamber 6.

The second main body portion 112 is formed in a tubular shape, and has a large-diameter accommodating portion 112a, a second passage 112b communicating with the accommodating portion 112a, and a fitting portion 112c formed at an opening-side end of the accommodating portion 112a. The second main body portion 112 is integrally fixed to the first main body portion 111 in a state of being air-tightly fitted with the outer peripheral side of the projecting portion 111a of the first main body portion 111 on the inner surface side of the fitting portion 112c. The accommodating portion 112a accommodates the valve seat 12, the valve body 13, and the spring 14. The second passage 112b that forms the passage communicates with the connecting pipe T connected to the vacuum pressure source 1.

The valve seat 12 is formed in the first passage 111c and the second passage 112b. Specifically, the valve seat 12 is formed on the distal end face of the projecting portion 111a of the first main body portion 111 accommodated in the accommodating portion 112a of the second main body portion 112. A dihedral angle of the distal end face of the projecting portion 111a with respect to a plane orthogonal to the axis J of the first passage 111c of the first main body portion 111, which is the axis of the passage, is zero. That is, the distal end face of the projecting portion 111a is orthogonal to the axis J of the first passage 111c.

The valve body 13 includes a base 131, a disk 132, and a protrusion 133. Here, the disk 132 and the protrusion 133 are integrally formed of the same elastic material, for example, the same rubber material.

The base 131 has a larger-diameter portion 131a accommodated in the accommodating portion 112a of the second main body portion 112, a smaller-diameter portion 131b inserted into the first passage 111c of the first main body portion 111, and a columnar neck portion 131c formed between the larger-diameter portion 131a and the smaller-diameter portion 131b. The larger-diameter portion 131a, the smaller-diameter portion 131b, and the neck portion 131c are arranged coaxially with the axis J of the first passage 111c.

In the larger-diameter portion 131a of the base 131, a spring seat 131d serving as a lock portion is formed on a surface opposite to a surface connected to the neck portion 131c to seat the end coil portion 141, described later, of the spring 14. The spring seat 131d is formed in a groove shape along the circumferential direction by the larger-diameter portion 131a and a disk-shaped flange portion 131e facing the larger-diameter portion 131a. The spring seat 131d is formed such that the size of the groove width in the direction along the axis J becomes greater than the length in the direction along the axis J of the end coil portion 141 in a state in which the end coil portion 141 of the spring 14 described below is accommodated. In the present embodiment, for the sake of convenience, the “axis of the passage” and the “axis of the urging member” are coaxial, and both are described as “axis J”.

The flange portion 131e has a tapered part 131e1 in which the outer diameter reduces in a direction away from the spring seat 131d along the axis J, that is, toward an expanding and contracting coil portion 142, described later, of the spring 14 at the outer peripheral end. Thus, when the end coil portion 141 of the spring 14 is locked to the spring seat 131d, the tapered part 131e1 increases the diameter of the end coil portion 141 along with the movement of the end coil portion 141 in the direction along the axis J, and the end coil portion 141 that has exceeded the tapered part 131e1 is locked by the groove-shaped spring seat 131d by reducing the diameter. Furthermore, the maximum outer diameter of the tapered part 131e1 is formed so as to be smaller than the inner diameter of a linking coil portion 143, described later, of the spring 14, and it does not come into contact with the linking coil portion 143 in a state in which the end coil portion 141 is locked to the spring seat 131d, that is, the spring 14 is assembled to the valve body 13.

Furthermore, the flange portion 131e of the base 131 is provided with a plurality of columnar legs 131f on the surface opposite to the surface forming the spring seat 131d. The leg 131f is provided so that when the atmospheric pressure is introduced into the variable pressure chamber 7 of the vacuum booster device 2 and a large amount of air flows from the first passage 111c to the second passage 112b, the opened valve body 13 does not block the second passage 112b. The leg 131f is formed of an elastic member (e.g., a rubber material or the like) in order to prevent abnormal noise generated when the valve body 13 is opened and abuts against the inner surface of the second main body portion 112.

The disk 132 is a disk having a larger diameter than the first passage 111c of the first main body portion 111, and as shown in FIG. 2, a through hole 132a through which the neck portion 131c of the base 131 is air-tightly penetrated is formed at the center portion. Furthermore, the disk 132 is formed in an umbrella shape having the position where the through hole 132a is formed as the vertex, and the protrusion 133 is integrally formed at an outer peripheral end. The protrusion 133 is formed so as to protrude facing the valve seat 12 in a state of being accommodated in the second main body portion 112, and forms a contact surface so as to make contact with the valve seat 12 for airtight seal in a seated state in which the valve body 13 is seated on the valve seat 12.

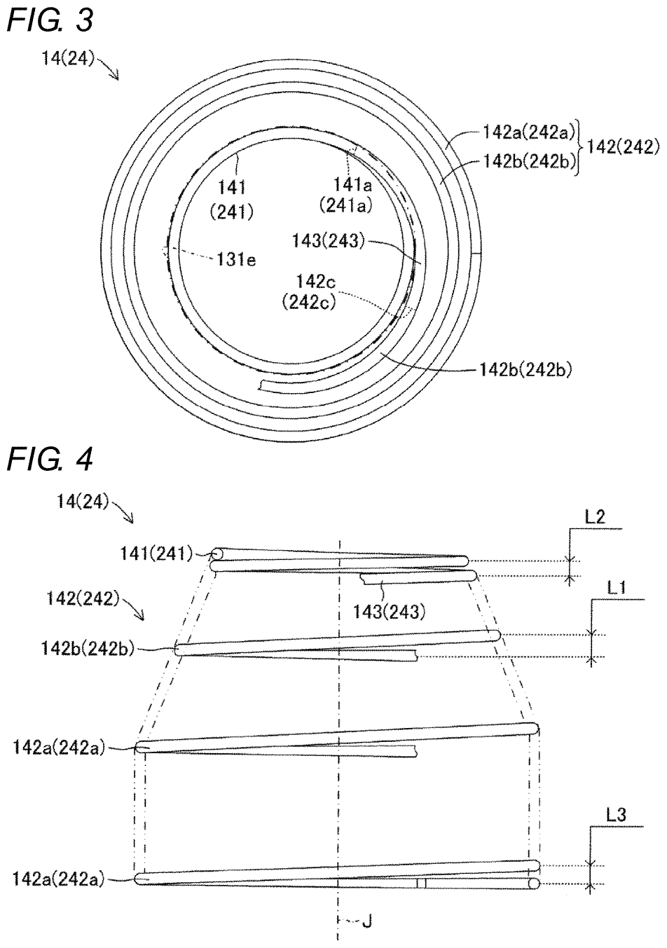

The spring 14 serving as the urging member is a coil spring formed in a spiral shape. The spring 14 is assembled inside the accommodating portion 112a of the second main body portion 112 in a pre-compressed state, and urges the valve body 13 toward the valve seat 12. As shown in FIGS. 3 and 4, the spring 14 includes the end coil portion 141, an expanding and contracting coil portion 142, and a linking coil portion 143.

The end coil portion 141 is accommodated in a spring seat 131d provided at the base 131 of the valve body 13, and the spring 14 is locked to the valve body 13. The end coil portion 141 has an inner diameter that is smaller than the outer diameter of the flange portion 131e forming the spring seat 131d, specifically, smaller than the maximum outer diameter of the tapered part 131e1, and larger than the outer diameter of the spring seat 131d (corresponding to the groove depth). Furthermore, the end coil portion 141 is formed such that the length in the direction along the axis J is smaller than the groove width of the spring seat 131d. Here, in the present embodiment, the end coil portion 141 is the first winding of the spiral-shaped spring 14, as shown in FIG. 2. In the present embodiment, the end coil portion 141 is configured by a single-wound wire rod, but may be configured by a plurality of wound wire rods.

The expanding and contracting coil portion 142 is separated from the flange portion 131e in the direction along the axis J, and is compressed from a pre-compressed state along the direction of the axis J as the valve body 13 separates (opens) from the valve seat 12 and is expanded to the pre-compressed state along the direction of the axis J as the valve body 13 seats (closes) on the valve seat 12. As shown in FIG. 4, the expanding and contracting coil portion 142 has a straight portion 142a that is parallel to the axis J, that is, a portion where the outer diameter and the inner diameter are constant along the direction of the axis J. The expanding and contracting coil portion 142 has a tapered portion 142b inclined with respect to the axis J, that is, has an inner diameter that is gradually reduced from the outer diameter and the inner diameter of the straight portion 142a along the direction of the axis J and is larger than the outer diameter of the flange portion 131e of the valve body 13 (more specifically, maximum outer diameter of the tapered part 131e1). Here, as shown in FIG. 4, in a free state in which the spring 14 is not accommodated in the second passage 112b (more specifically, the accommodating portion 112a), the tapered portion 142b is molded to have a winding pitch L1 representing an interval between the wire rods in the direction along the axis J. Furthermore, as shown in FIG. 4, in the free state, the straight portion 142a is molded to have a winding pitch L3 smaller than the winding pitch L1 of the tapered portion 142b and greater than a winding pitch L2, described later, of the linking coil portion 143.

The linking coil portion 143 links a winding end portion 141a of the end coil portion 141 to become a base point separated from the spring seat 131d and a winding end portion 142c of the expanding and contracting coil portion 142 (more specifically, tapered portion 142b) separated from the flange portion 131e on the valve body 13 side, and separates them from the flange portion 131e and the spring seat 131d. In the present embodiment, the linking coil portion 143 is the second winding of the spiral-shaped spring 14, as shown in FIG. 2. In the present embodiment, the linking coil portion 143 is configured by a single-wound wire rod, but may be configured by a plurality of wound wire rods.

As shown in FIG. 3, in the linking coil portion 143, an inner diameter at the end on the end coil portion 141 side is smaller than the outer diameter of the flange portion 131e, and an inner diameter at the end on the expanding and contracting coil portion 142 side (more specifically, tapered portion 142b) is larger than the outer diameter of the flange portion 131e forming the spring seat 131d (more specifically, maximum outer diameter of the tapered part 131e1 formed at the outer peripheral end) and smaller than the minimum outer diameter of the tapered portion 142b of the expanding and contracting coil portion 142. Here, as shown in FIG. 4, the winding pitch L2 of the linking coil portion 143 is molded to be smaller than the winding pitch L1 of the expanding and contracting coil portion 142 in a free state. When the end coil portion 141 is wound plural times, the winding pitch L2 of the linking coil portion 143 is molded to be smaller than the winding pitch L1 of the expanding and contracting coil portion 142 and greater than the winding pitch L4 of the end coil portion 141 (not shown).).

Next, the operation of the check valve 10 configured as described above will be described. In the check valve 10, when the brake pedal P is depressed, atmospheric pressure is introduced into the variable pressure chamber 7 and air flows into the vacuum pressure chamber 6, so that the air in the vacuum pressure chamber 6 flows to the first passage 111c of the main body 11. Thus, when the pressure of the vacuum pressure chamber 6 becomes greater than the urging force of the spring 14, the valve body 13 separates from the valve seat 12, thus allowing communication of air from the vacuum pressure chamber 6 toward the vacuum pressure source 1 through the vacuum pressure inlet port 3, that is, from the first passage 111c toward the second passage 112b.

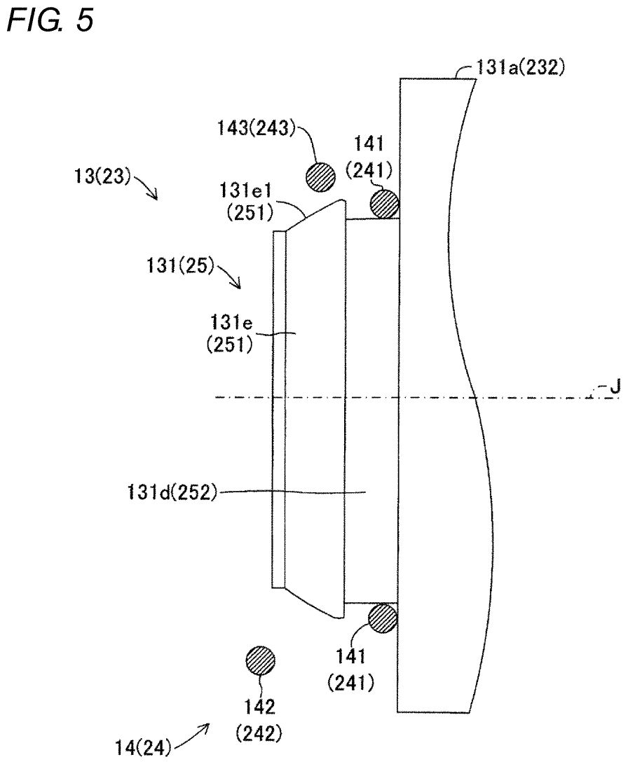

When the valve body 13 is separated from the valve seat 12, the tapered portion 142b of the expanding and contracting coil portion 142 contracts in the spring 14. In this case, as shown in FIG. 5, since the linking coil portion 143 is separated from the flange portion 131e, the linking coil portion 143 does not abut against (interfere with) the tapered part 131e1 of the flange portion 131e even if it is pressed in the direction of the spring seat 131d as the tapered portion 142b of the expanding and contracting coil portion 142 is contracted. Furthermore, as the linking coil portion 143 does not abut against the tapered part 131e1 of the flange portion 131e, the contracting operation of the expanding and contracting coil portion 142 (tapered portion 142b) is not affected. Therefore, since the spring 14 urges the valve body 13 by a preset urging force (elastic force), the check valve 10 allows the communication of air from the first passage 111c to the second passage 112b based on the operating characteristics set in advance.

After elapse of time from when the depressing operation of the brake pedal P is started, the pressure difference (vacuum pressure difference) between the vacuum pressure chamber 6 and the vacuum pressure source 1 gradually decreases as the vacuum pressure source 1 suctions in air. Therefore, the pressure difference (vacuum pressure difference) between the first passage 111c and the second passage 112b also gradually decreases. As described above, when the pressure difference (vacuum pressure difference) between the first passage 111c and the second passage 112b gradually decreases, the valve body 13 gradually displaces from the second passage 112b side toward the first passage 111c side by the urging force of the spring 14, that is, in a direction of seating on the valve seat 12.

Even in a state in which the valve body 13 is displaced in the direction of seating on the valve seat 12, the air flows from the vacuum pressure chamber 6 toward the vacuum pressure source 1 through the vacuum pressure inlet port 3. The balance between the magnitude of the pressure acting on the valve body 13 from the flowing air atmosphere and the magnitude of the urging force acting on the valve 13 from the spring 14 may collapse by the suction cycle of air by the vacuum pressure source 1 (e.g., an engine manifold etc.). In this case, the expanding and contracting coil portion 142 of the spring 14 may vibrate. Even with respect to such vibration of the spring 14 (expanding and contracting coil portion 142), since the linking coil portion 143 is separated from the flange portion 131e, the linking coil portion 143 does not repeatedly abut against the flange portion 131e to vibrate the valve body 13, and generation of abnormal noise and the like due to the repeated abutment of the valve body 13 to the valve seat 12 is suppressed.

After further elapse of time from when the depressing operation of the brake pedal P is started, the pressure difference (vacuum pressure difference) between the vacuum pressure chamber 6 and the vacuum pressure source 1 further decreases as the vacuum pressure source 1 continuously suctions air. Therefore, in this case, the pressure difference (vacuum pressure difference) between the first passage 111c and the second passage 112b further decreases. As described above, when the pressure difference (vacuum pressure difference) between the first passage 111c and the second passage 112b becomes smaller, the valve body 13 is in a seated state by the urging force of the spring 14. Thus, the check valve 10 shuts off the communication of air from the vacuum pressure chamber 6 toward the vacuum pressure source 1 through the vacuum pressure inlet port 3, that is, from the first passage 111c toward the second passage 112b.

Then, even in the seated state, the vacuum pressure source 1 continues to suction air present in the second passage 112b. At this time, a vacuum pressure pulsation (e.g., air resonance) may occur in the second passage 112b connected to the connecting pipe T by the suction cycle of air by the vacuum pressure source 1. The vacuum pressure pulsation thus generated acts to excite vibration on the spring 14 in the seated state. When the expanding and contracting coil portion 142 of the spring 14 vibrates due to such vacuum pressure pulsation, the end coil portion 141 presses the larger-diameter portion 131a of the base 131 along the direction of the axis J. Furthermore, since the expanding and contracting coil portion 142 and the linking coil portion 143 are separated from the flange portion 131e and the spring seat 131d, the expanding and contracting coil portion 142 and the linking coil portion 143 are avoided from repeatedly abutting against the flange portion 131e. Therefore, even when the expanding and contracting coil portion 142 of the spring 14 vibrates due to the vacuum pressure pulsation, the spring 14 does not vibrate the valve body 13, and as a result, generation of abnormal noise and the like due to the vibration of the valve body 13 is suppressed.

As can be understood from the above description, the vacuum booster device 2 of the embodiment described above includes a hollow booster shell 4, a movable partition wall 5 that air-tightly divides the booster shell 4 into a vacuum pressure chamber 6 and a variable pressure chamber 7, a booster piston 8 that is provided relatively movable with respect to the booster shell 5 and that moves integrally with the movable partition wall 5 inside the booster shell 4, and a check valve 10 that is assembled to the vacuum pressure inlet port 3 communicating to the vacuum pressure chamber 6 of the booster shell 4 and connected to the vacuum pressure source 1 of the vehicle, and that allows communication of air from the vacuum pressure inlet port 3 toward the vacuum pressure source 1 and shuts off communication of the air from the vacuum pressure source 1 toward the vacuum pressure inlet port 3.

The check valve 10 includes a main body 11 provided so as to be connected to the vacuum pressure inlet port 3, a first passage 111c and a second passage 112b formed in the main body 11 to serve as a passage for communicating the vacuum pressure inlet port 3 and the vacuum pressure source 1, a valve seat 12 formed in the passage, a valve body 13 that is accommodated in the passage to be seated on or separated from the valve seat 12 and that includes a cylindrical base 131 extended toward the passage in the direction of the axis J, a disk 132 extending along the radial direction of the base 131, an annular protrusion 133 projecting out toward the valve seat 12 from the outer peripheral end of the disk 132, and a spring seat 131d serving as groove-shaped lock portion provided on the base 131 to extend along the radial direction of the base 131 and include a flange portion 131e facing the disk 132 and the disk 132, and a spring 14 serving as a spiral-shaped urging member accommodated in the passage to urge the valve body 13 toward the valve seat 12 to bring the protrusion 133 into contact with the valve seat 12, where the spring 14 is configured to include an end coil portion 141 locked to the spring seat 131d, an expanding and contracting coil portion 142 that is brought into contact with the main body 11 and separated from the flange portion 131e to expand and contract according to the seating or separation of the valve body 13, and a linking coil portion 143 that links a winding end portion 141a of the end coil portion 141 acting as a base point separated from the spring seat 131d and a winding end portion 142c of the expanding and contracting coil portion 142 separated from the flange portion 131e on the valve body 13 side and separates then from the flange portion 131e and the spring seat 131d.

In this case, more specifically, the expanding and contracting coil portion 142 is configured by a straight portion 142a parallel to the axis J of the spring 14, and a tapered portion 142b inclined with respect to the axis J, where the linking coil portion 143 links the winding end portion 141a of the end coil portion 141 and the winding end portion of the tapered portion 142b of the expanding and contracting coil portion 142. In this case, in the linking coil portion 143, the inner diameter at the end on the end coil portion 141 side is smaller than the outer diameter of the flange portion 131e, and the inner diameter of the end on the expanding and contracting coil portion 142 side is larger than the outer diameter of the flange portion 131e and smaller than the minimum outer diameter of the tapered portion 142b.

According to these, the linking coil portion 143 linking the end coil portion 141 and the expanding and contracting coil portion 142 of the spring 14 can be separated from the flange portion 131e of the valve body 13. Thus, when a vacuum pressure pulsation occurs in the first passage 111c and the second passage 112b during the seated state in which the valve body 13 is seated on the valve seat 12, and the expanding and contracting coil portion 142 of the spring 14 expands/contracts and vibrates, the expanding and contracting coil portion 142 and the linking coil portion 143 linking the expanding and contracting coil portion 142 and the end coil portion 141 can be avoided (suppressed) from abutting against the flange portion 131e and the spring seat 131d of the valve body 13. Therefore, even if the spring 14 is expanded and contracted by the vacuum pressure pulsation, the spring 14 does not vibrate the valve body 13, so that an abnormal sound (abutment noise) generated when the valve body 13 repeatedly abuts against the valve seat 12 can be suppressed.

Furthermore, the expanding and contracting coil portion 142 and the linking coil portion 143 do not abut (interfere with) the flange portion 131e of the valve body 13. Thus, the expanding and contracting operation of the expanding and contracting coil portion 142 is not hindered at all, and hence the operating characteristics set for the check valve 10, that is, the urging force (load characteristic) applied from the spring 14 when the valve body 13 is seated on or separated from the valve seat 12 does not change. Therefore, the check valve 10 can exhibit good operating characteristics.

In this case, in a free state in which the spring 14 is not accommodated in the first passage 111c and the second passage 112b, that is, in the accommodating portion 112a of the main body 11, the size of the winding pitch L2 of the linking coil portion 143 in the direction along the axis J of the spring 14 is set to be smaller than the size of the winding pitch L1 of the expanding and contracting coil portion 142. When the end coil portion 141 is formed by winding a plurality of windings, the winding pitch L2 of the linking coil portion 143 is set to be greater than the size of the winding pitch L4 of the end coil portion 141.

Therefore, the linking coil portion 143 can be further separated from the flange portion 131e in the direction along the axis J. Thus, the tapered portion 142b of the expanding and contracting coil portion 142 and the linking coil portion 143 are surely separated from the flange portion 131e in the direction along the axis J and in the radial direction perpendicular to the axis J, and abutment (interference) with the flange portion 131e can be more reliably avoided.

In these cases, the end coil portion 141 is formed such that the length of the spring 14 in the direction along the axis J is smaller than the groove width of the spring seat 131d in a state in which the end coil portion 141 is locked to the spring seat 131d of the base 131.

Thus, the end coil portion 141 does not abut (interfere) with the spring seat 131d even when the spring 14 vibrates due to the vacuum pressure pulsation in a state in which the end coil portion 141 is locked on the spring seat 131d of the base 131. Therefore, the valve body 13 is not vibrated and the occurrence of abnormal noise can be suppressed more reliably.

In these cases, the flange portion 131e has a tapered part 131e1 in which the outer diameter decreases in a direction away from the spring seat 131d along the axis J at the outer peripheral end.

As the tapered part 131e1 is provided at the outer peripheral end of the flange portion 131e, the linking coil portion 143 linked to the winding end portion 142c of the expanding and contracting coil portion 142 can be reliably separated from the flange portion 131e. Therefore, the linking coil portion 143 can be more reliably avoided from abutting (interfering) with the flange portion 131e.

### MODIFIED EXAMPLE

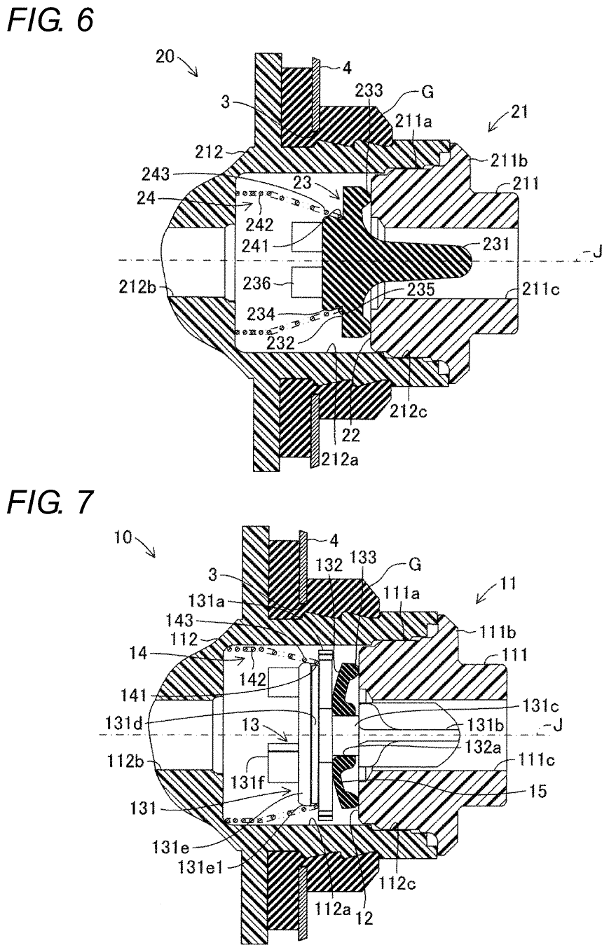

In the embodiment described above, the check valve 10 is provided so as to include the valve body 13 including the base 131, the disk 132, and the protrusion 133. Alternatively, the base, the disk, and the protrusion may be integrally formed of a rubber material which is an elastic material. That is, in this modified example, as shown in FIG. 6, a check valve 20 is different from the check valve 10 in the embodiment described above in including a valve body 23, which is an integrally molded product in which a base 231, a disk 232, a protrusion 233, a flange portion 234, a spring seat 235, and a leg 236 are integrally formed.

As shown in FIGS. 1 and 6, the check valve 20 is air-tightly assembled to the vacuum pressure inlet port 3 formed in the booster shell 4 through a grommet G. As shown in FIG. 6, the check valve 20 includes a main body 21, a valve seat 22, a valve body 23, and a spring 24. The main body 21 includes a first main body portion 211 and a second main body portion 212.

The first main body portion 211 and the second main body portion 212 correspond to the first main body portion 111 and the second main body portion 112 forming the main body 11 of the embodiment described above, and have the same configuration. Specifically, a projecting portion 211a, a flange portion 211b, and a first passage 211c of the first main body portion 211 correspond to the projecting portion 111a, the flange portion 111b, and the first passage 111c of the first main body portion 111 of the embodiment described above, and have the same configuration. In addition, an accommodating portion 212a, a second passage 212b, and a fitting portion 212c of the second main body portion 212 correspond to the accommodating portion 112a, the second passage 112b, and the fitting portion 112c of the second main body portion 112 of the embodiment described above, and have the same configuration. The valve seat 22 corresponds to the valve seat 12 of the above embodiment described above, and has the same configuration.

Furthermore, as shown in FIGS. 3 and 4, the spring 24 corresponds to the spring 14 of the embodiment described above, and has the same configuration. Specifically, an end coil portion 241, an expanding and contracting coil portion 242 (straight portion 242a and tapered portion 242b), a linking coil portion 243, a winding end portion 241a and a winding end portion 242c of the spring 24 correspond to the end coil portion 141, the expanding and contracting coil portion 142 (straight portion 142a and tapered portion 142b), the linking coil portion 143, the winding end portion 141a, and the winding end portion 142c of the spring 14 of the embodiment described above, and have the same configuration.

The valve body 23 includes a base 231, a disk 232, a protrusion 233, a flange portion 234, a spring seat 235, and a leg 236. In this modified example, the base 231, the disk 232, the protrusion 233, the flange portion 234, the spring seat 235, and the leg 236, that is, the valve body 23 are integrally formed of a rubber material which is an elastic member. Here, the rubber material forming the valve body 23 is preferably a rubber material having high rigidity. Specifically, in a seated state of the valve body 23 with respect to the valve seat 22, a rubber material having a rigidity of an extent the valve body 23 is not deformed and displaced into the first passage 211c is preferably selected under a situation where air flows from the vacuum pressure source 1 toward the vacuum pressure chamber 6, that is, a situation where the pressure in the second passage 212b becomes higher than the pressure in the first passage 211c.

The base 231 is formed in a solid cylindrical shape so as to extend in the direction of the axis J of the first passage 211c, and the distal end side enters the first passage 211c of the first main body portion 211. The disk 232 is formed on the basal end side of the base 231 so as to extend in the radial direction of the base 231. The protrusion 233 is formed in an annular shape at the outer peripheral end of the disk 232. The protrusion 233 is formed so as to protrude facing the valve seat 22 in a state of being accommodated in the second main body portion 212, and is brought into contact with the valve seat 22 in a seated state in which the valve body 23 is seated on the valve seat 22. When the valve body 23 is in the seated state, the protrusion 233 forms a contact surface with the valve seat 22 for airtight seal.

The flange portion 234 has a smaller diameter than the outer diameter of the disk 232, and forms a spring seat 235 that engages with the end coil portion 241 of the spring 24 together with the disk 232 of the valve body 23. Furthermore, a tapered part 234a is provided at an outer peripheral end of the flange portion 234. The leg 236 is provided so that when the atmospheric pressure is introduced into the variable pressure chamber 7 of the vacuum booster device 2 and a large amount of air flows from the first passage 211c toward the second passage 212b, the opened valve body 23 does not block the second passage 212b.

In the modified example configured as above as well, as shown in FIG. 5, the linking coil portion 243 of the spring 24 is avoided from abutting (interfering) with the flange portion 234, similarly to the above embodiment. Therefore, effects similar to those of the embodiment described above can be obtained.

The implementation of the present invention is not limited to the above embodiment and the above modified example, and various modifications can be made without departing from the purpose of the present invention.

In the embodiment described above, the linking coil portion 143 of the spring 14 links the end coil portion 141 and the expanding and contracting coil portion 142 so as not to abut (interfere) with the spring seat 131d and the flange portion 131e of the base 131 of the valve body 13 (valve body 23). Further, in the modified example described above, the linking coil portion 243 of the spring 24 links the end coil portion 241 and the expanding and contracting coil portion 242 so as not to abut (interference) with the spring seat 235 and the flange portion 234 of the valve body 23. Thus, even when the spring 14 and the spring 24 vibrate due to the vacuum pressure pulsation, the valve body 13 and the valve body 23 are suppressed from vibrating.

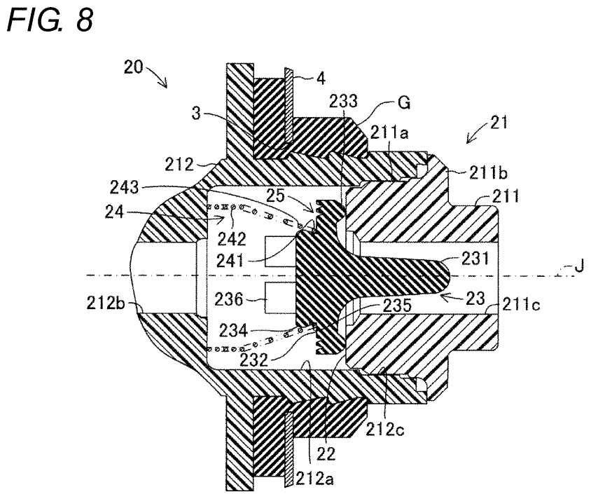

In this case, as shown in FIGS. 7 and 8, the valve body 13 (valve body 23) may include a vibration absorber 15 (vibration absorber 25) that absorbs more vibration applied to the valve body 13 (valve body 23) at one portion of the valve body 13 (valve body 23) than other portions of the valve body 13 (valve body 23), for example, in a seated state where the valve body 13 (valve body 23) is seated on the valve seat 12 (valve seat 22).

Specifically, in the case of the valve body 13, as shown in FIG. 7, a thin portion having a smaller plate thickness than other portions is formed as the vibration absorber 15 at one portion of the disk 132. Thus, when the entire valve body 13 attempts to vibrate due to the vacuum pressure pulsation, one portion of the disk 132 having a small rigidity, that is, the vibration absorber 15 starts to vibrate before the other portions of the disk 132. As described above, as the vibration absorber 15 starts to vibrate first, the vibration energy that vibrates the entire valve body 13 provided from the air by the vacuum pressure pulsation is consumed. As a result, it is possible to prevent the entire valve body 13 from vibrating, and the entire valve body 13 from repeating seating and separating with respect to the valve seat 12.

In this case, since the vibration absorber 15 has small rigidity, even if the protrusion 133 close to the vibration absorber 15 repeats the separation and seating with respect to the valve seat 12 with the vibration of the vibration absorber 15, the impact load exerted on the valve seat 12 by the protrusion 133 when seated is reduced. Therefore, the occurrence of abutment noise caused by the vibration of the valve body 13 can be suppressed.

In the case of the valve body 23, concentric grooves are formed as the vibration absorber 25, as shown in FIG. 8. Thus, when the entire valve body 23 attempts to vibrate due to the vacuum pressure pulsation, the vicinity of the groove having a small rigidity, that is, the vibration absorber 25 starts to vibrate before the other portions where the groove is not formed. As described above, as the vibration absorber 25 starts to vibrate first, the vibration energy that vibrates the entire valve body 23 provided from the air by the vacuum pressure pulsation is consumed. As a result, it is possible to prevent the entire valve body 23 from vibrating, and the entire valve body 23 from repeating seating and separating with respect to the valve seat 22.

In this case, since the vibration absorber 25 has small rigidity, even if the protrusion 233 close to the vibration absorber 25 repeats the separation and seating with respect to the valve seat 22 with the vibration of the vibration absorber 25, the impact load exerted on the valve seat 12 by the protrusion 233 when seated is reduced. Therefore, the occurrence of abutment noise caused by the vibration of the valve body 23 can be suppressed.

In the above embodiment and the above modified example, the check valve 10 and the check valve 20 are assembled through the grommet G to the vacuum pressure inlet port 3 formed in the booster shell 4 of the vacuum booster device 2. In this case, when the booster shell 4 of the vacuum booster device 2 is made of resin, for example, the first main body portions 111 and 211 can be formed integrally with the booster shell 4. Therefore, there is no need for the work of fixing the first main body portions 111 and 211 to the booster shell 4, and the manufacturing cost can be reduced.

In the above embodiment and the above modified example, the check valve 10 and the check valve 20 are directly assembled to the vacuum booster device 2. In this case, for example, the check valve 10 and the check valve 20 can be assembled inside the connecting pipe T or to an intermediate portion of the connecting pipe T. Therefore, there is no need to secure a space for installing the check valve 10 and the check valve 20 at the periphery of the vacuum booster device 2, and a degree of freedom of arrangement of the vacuum booster device 2 can be ensured.

1-5. (canceled)

6. A vacuum booster device comprising:
a hollow booster shell;
a movable partition wall that air-tightly partitions the booster shell into a vacuum pressure chamber and a variable pressure chamber;
a booster piston that is provided to be relatively movable with respect to the booster shell, and that moves integrally with the movable partition wall inside the booster shell; and
a check valve that is assembled to a vacuum pressure inlet port communicating with the vacuum pressure chamber of the booster shell and connected to a vacuum pressure source of a vehicle, and that allows communication of air from the vacuum pressure inlet port toward the vacuum pressure source and shuts off communication of the air from the vacuum pressure source toward the vacuum pressure inlet port, wherein
the check valve includes:
a main body provided to connect with the vacuum pressure inlet port;
a passage that is formed in the main body to communicate the vacuum pressure inlet port and the vacuum pressure source;
a valve seat formed in the passage;
a valve body that is accommodated in the passage and seated on or separated from the valve seat, and that includes a cylindrical base that extends into the passage in a direction of an axis, a disk that extends along a radial direction of the base, an annular protrusion that projects out toward the valve seat from an outer peripheral end of the disk, and a groove-shaped lock portion provided on the base to extend along the radial direction of the base and include a flange portion facing the disk and the disk; and
a spiral-shaped urging member that is accommodated in the passage and that urges the valve body toward the valve seat to bring the protrusion into contact with the valve seat, and
the urging member is configured to include:
an end coil portion locked to the lock portion;
an expanding and contracting coil portion that makes contact with the main body and is separated from the flange portion, and that expands and contracts according to the seating or separation of the valve body; and
a linking coil portion that links a winding end portion of the end coil portion that becomes a base point separated from the lock portion and a winding end portion of the expanding and contracting coil portion separated from the flange portion on the valve body side, and that separates the winding end portions from the flange portion and the lock portion, in a free state in which the urging member is not accommodated in the passage, a size of a winding pitch of the linking coil portion in a direction along the axis of the urging member being smaller than a size of a winding pitch of the expanding and contracting coil portion and greater than a size of a winding pitch of the end coil portion.

7. The vacuum booster device according to claim 6, wherein the expanding and contracting coil portion is configured by a straight portion parallel to the axis of the urging member and a tapered portion inclined with respect to the axis, and the linking coil portion links the winding end portion of the end coil portion and the winding end portion of the tapered portion of the expanding and contracting coil portion.

8. The vacuum booster device according to claim 7, wherein
in the linking coil portion,
an inner diameter at an end on the end coil portion side is smaller than an outer diameter of the flange portion, and an inner diameter at an end on the expanding and contracting coil portion side is larger than the outer diameter of the flange portion and smaller than a minimum outer diameter of the tapered portion.

9. The vacuum booster device according to claim 6, wherein the flange portion includes, at an outer peripheral end, a tapered part in which an outer diameter becomes smaller along a direction of separating from the lock portion along the axis.

10. The vacuum booster device according to claim 7, wherein the flange portion includes, at an outer peripheral end, a tapered part in which an outer diameter becomes smaller along a direction of separating from the lock portion along the axis.

11. The vacuum booster device according to claim 8, wherein the flange portion includes, at an outer peripheral end, a tapered part in which an outer diameter becomes smaller along a direction of separating from the lock portion along the axis.
